(19) United States
(12) Patent Application Publication
(10) Pub. No.: US 2015/0310069 A1
(43) Pub. Date: Oct. 29, 2015

(54) METHODS AND SYSTEM TO PROCESS STREAMING DATA

(71) Applicant: Teradata US, Inc., Dayton, OH (US)

(72) Inventor: Gregory Howard Milby, San Marcos, CA (US)

(73) Assignee: Teradata US, Inc., Dayton, OH (US)

(21) Appl. No.: 14/263,439

(22) Filed: Apr. 28, 2014

(51) Int. Cl. G06F 17/30

(52) U.S. Cl. CPC G06F 17/30516; G06F 17/30339

(57) ABSTRACT

Streaming data is populated to an in-memory data table and a continuous query is executed against an in-memory data table using a database interface to perform analytical operations on the populated in-memory data table. Results from the analytical operations performed are streamed to consuming applications.

### BACKGROUND

A new emerging paradigm and accompanying technology are occurring in the database arena with respect to: Big Data (BD) and Streaming Data Analysis (SDA). Streaming data analysis has to do with the ability to perform real-time analysis against live streaming data feeds. Examples of streaming data feeds include but are not limited to: live stock ticker data, live Global Positioning Satellite (GPS) data, Internet message streams, cell phone records, and a myriad of sensor data from a variety of sources, such as gas/electric utilities, marine buoy data, etc.

In a typical streaming data application, a Streams Processing Engine (SPE) is utilized as the analytical processor that invokes a suite of analytical tasks, which are interconnected to form a data processing flow graph. These tasks are then fed a continuous stream of data records, which may be structured or mostly unstructured, and which flow through the analytical graph to produce a continuous stream of results.

Since this class of operations and accompanying technology are relatively new, there is not a universal standard regarding how one is to feed data over to the analytical tasks and how one is to invoke the application itself. Various commercial database companies and new streaming-data-centric startup companies are inventing various constructs to represent the streaming data connections, which are used to feed the streaming data from its source to the SPE and stream the data between the interconnected tasks to form the analytical directed flow graph. Most of these approaches involve the introduction of brand new database objects (input stream objects, output stream objects, intermediate stream objects; stream feed “channels”, etc.). The problem with introducing new objects is that it creates confusion by adding to an already overpopulated collection of Structured Query Language (SQL) constructs and it makes it troublesome for seasoned database application developers to grasp the concepts they need to formulate a successful streaming data application.

### SUMMARY

In various embodiments, methods and a system are taught for processing streaming data. According to an embodiment, a method for processing streaming data is provided.

Specifically, a Streaming Data Table (SDT) is defined and a database interface is accessed to create an instance of the SDT in memory. Next, streaming data is received from at least one streaming source over a network and the streaming data is populated into the SDT through the database interface.

### BRIEF DESCRIPTION OF THE DRAWINGS

FIG. 1 is diagram depicting components for receiving and processing streaming data, according to an example embodiment.

FIG. 2 is a diagram of a method for processing streaming data, according to an example embodiment.

FIG. 3 is a diagram of another method for processing streaming data, according to an example embodiment.

FIG. 4 is a diagram of a streaming processing system, according to an example embodiment.

### DETAILED DESCRIPTION

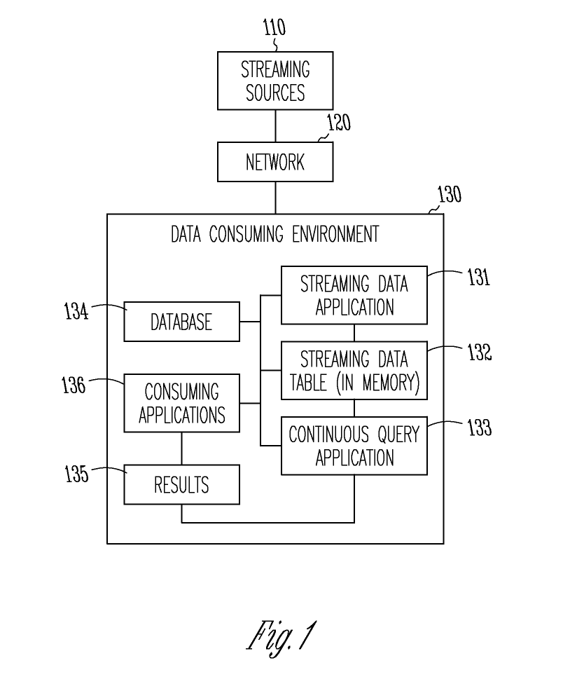

FIG. 1 is diagram depicting components for receiving and processing streaming data, according to an example embodiment. The diagram depicts a variety of components, some of which are executable instructions implemented as one or more software modules, which are programmed within memory and/or non-transitory computer-readable storage media and executed on one or more processing devices (having memory, storage, network connections, one or more processors, etc.).

The diagram is depicted in greatly simplified form with only those components necessary for understanding embodiments of the invention depicted. It is to be understood that other components may be present without departing from the teachings provided herein.

The diagram includes a variety of streaming sources 110, a variety of networks 120, and at least one streaming data consuming processing environment 130. The streaming data consuming environment 130 (herein after “consuming environment 130”) includes a streaming data application 131, a streaming data table 132 (housed wholly in memory), a continuous query application 133, a database 134 (or multiple databases operating as a data warehouse), results 135 produced from the database 134, and consuming applications 135.

The streaming sources 110 provide real-time data feeds from a variety of sources, a variety of information, and from a variety of network feeds. By way of example only, the streaming sources 110 include GPS data, cell phone data, Internet data, etc. The information streamed can include a variety of information, such as and by way of example only, stock ticker information, news information, sensor information (marine buoys, utilities, etc.), weather information, financial information, sports information, retail information, and the like.

The streaming sources 110 stream the data to subscribers (such as the consuming environment 130) over one or more networks 120.

The networks 120 can include, by way of example only, Internet, cellular, satellite, and others.

The consuming environment 130 includes one or more hardware devices networked together in a Local Area Network (LAN) or Wide Area Network (WAN). The consuming environment 130 also includes a variety of software resources, some of which are depicted in the diagram.

The streaming data application 131 receives the streaming data over the networks 120 from the streaming sources 110 within the consuming environment. A conventional streaming application would parse the data for tags, data offsets, identifiers, and the like to process the streaming data in an interconnected graph of results, which then generates results that are useful and understood by consuming applications. However, as discussed herein, this conventional processing is enhanced to create an in-memory streaming data table 132 from the streaming data to serve as a source from which a CQ 133 can perform interconnected tasks utilizing a database 134 and that database's interface (such as SQL).

Most commercial database vendors offer a CREATE TABLE Data Definition Language (DDL) statement. This statement is used currently by those vendors to enable SQL users to create either volatile or non-volatile tables, which can then be used to store persistent data (data stored on some form of a physical disk drive). The conventional DDL statement is enhanced with the embodiments here. The enhanced DDL statement appears as follows (in an embodiment):

### Example DDL Syntax:

```
<create stream table> ::=
        CREATE [STREAM] TABLE <table name>
          <comma> WITH BUDGET <equals> <sdt_instance_size>
              [<comma>  {EXECUTE  ZONE  PERCENT
<equals> <integral_value>}
                  |  {EXECUTE  ZONE  COUNT
<equals> <integral_value>}]
          <left paren> <column definitions> <right paren>
          <semi colon>
<column definitions> ::=
<column definition> [ { <comma> < column definition> } ... ]
<column definition> ::= !!may employ any of the existing
data types offered by the database in which this is implemented.
<sdt_instance_size> ::= the amount of memory, in bytes, to be allocated
          on behalf of a single SDT instance, serving the role
          of  a  streaming  data  table  or  streaming  data
spool (intermediate result table).
```

### Syntax Description:

This statement defines a Streaming Data Table 132 (SDT 132), which is a special wholly “in-memory” table that is used in conjunction with the streaming data application 131. The created SDT 132 may also be referred to as the Source SDT 132, as it serves as the source for streaming data that is fed into the Continuous Query Application 133 (referred to here as “CQ 133”).

The BUDGET statement in the DDL gives a streaming developer some control over the amount of memory that is to be used to hold streaming data. The BUDGET applies to the size of the SDT 132 defined by the CREATE STREAM TABLE statement. Created instances of SDT 132 use an on-demand model so the size sets the upper limit of the memory for any particular SDT 132. The BUDGET also establishes an upper limit on any spool instances of the SDT 132 that may be employed as part of a CQ 133 against the SDT source 132.

The EXECUTE ZONE PERCENT of the DDL statement gives a streaming developer an opportunity to control the number of Execution Units (such as Access Module Processors (AMPs)) on which an instance of the CQ 133, which is reading from the SDT 132 executes, so multiple instances of the CQ 133 can exist in a distributed and parallel processing database environment.

### Database 134

Existing database servers and databases can be enhanced to support the CREATE STREAM TABLE DDL statement by:
1) Making entries into dictionary tables or the catalog in support of the CREATE STREAM TABLE. This enables the context to be retrieved when a CQ 133 is submitted, which references the SDT 132.
2) Making minimal contextual entries in persistent storage, such that number of fields and field type information is available at runtime. In an embodiment, this is achieved by creating and storing a Table Header on all of the AMPs, on behalf of the newly created SDT 132.
3) Support the SDT 132 with an in-memory table implementation.

The CQ 133 continuously executes queries against the SDT 132 using the database 134 and processes necessary analytical tasks to produce results 135, which are then continuously fed to consuming applications 136.

The analytic processing on the streaming data occurs though the queries that transform the data through the CQ133. Thus, the conventional approach of parsing the streaming data using tags and objects for functions can be structured and captured and processed against the in-memory SDT 132 using the database 134 from which the results 135 are produced by the CQ 133 and fed to consuming applications 136.

It is noted that SQL database users already understand the concept of a table, which is available in both permanent (persistent) and volatile (memory) forms. Thus for a database developer, it is easy to grasp the concept that the existing “table” paradigm has now been extended to serve as a source for streaming data (SDT 132) that can then be accessed in a structured formal in real time by the CQ 133, which executes the interconnected analytical tasks as an enhanced streams processing engine.

The techniques herein teach a more reliable structure and processing flow for processing streaming data. Some of these benefits include, by way of example only:
a) For a database developer, the “table” paradigm is understood well. By exploiting this familiarity, many previous difficult aspects of dealing with live streaming data become substantially simplified.
b) The fact that a SDT 132 is created via a CREATE TABLE statement means that a Database Administrator is provided with control over the access rights associated with the SDT 132. An instance of the CQ 133, which references an instance of the SDT132 is issued by a user having access rights to any instances of the SDT 132 referenced within the CQ 133.
c) The fact that the SDT 132 follows the table paradigm can be further exploited, logic can be added that enables the user to define Triggers on the SDT 132; and/or define Secondary Indexes on the SDT 132.

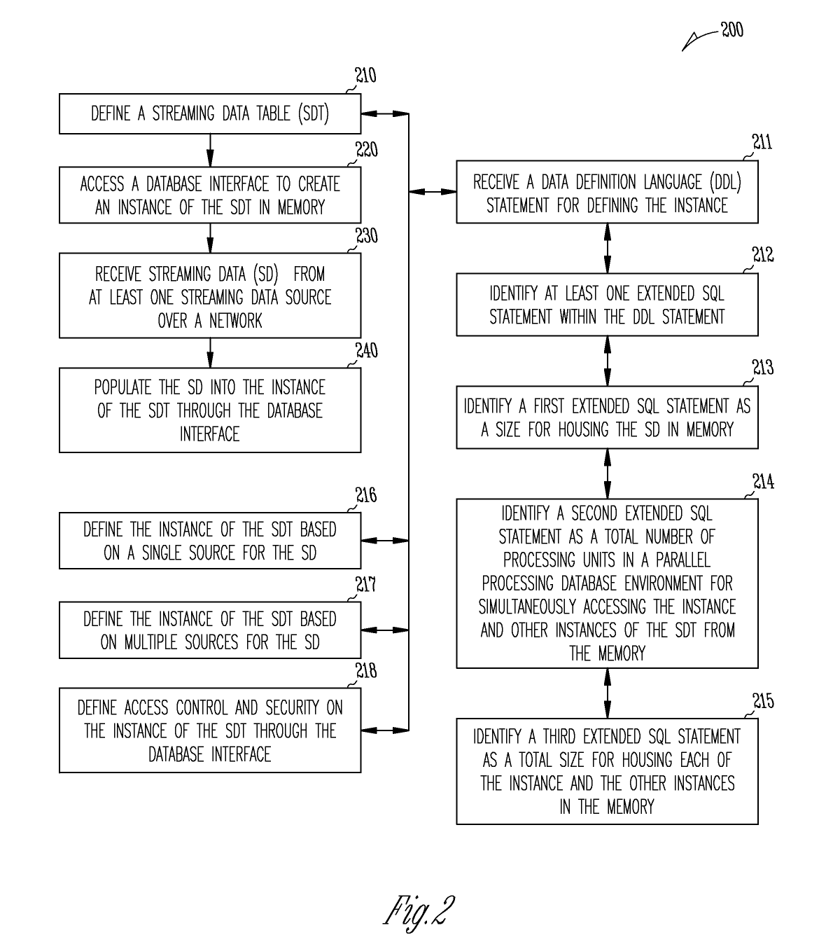

The above-discussed embodiments and other embodiments are now discussed with reference to the FIGS. 2-4.

FIG. 2 is a diagram of a method 200 for processing streaming data, according to an example embodiment. The method 200 (hereinafter “streaming data table manager (SDTM)”) is implemented as executable instructions (as one or more software modules) within memory and/or non-transitory computer-readable storage medium that execute on one or more processors, the processors specifically configured to execute the SDTM. Moreover, the SDTM collector is programmed within memory and/or a non-transitory computer-readable storage medium. The SDTM may have access to one or more networks, which can be wired, wireless, or a combination of wired and wireless.

In an embodiment, the SDTM is the streaming data application 131 of the FIG. 1, which creates the SDT 132 and uses the CQ 133.

At 210, the SDTM defines novel completely in-memory streaming data table (SDT). This can be achieved in a number of manners.

For example, at 211 receives a DDL statement for defining the instance of the SDT. An example syntax for such a DDL statement was provided above with reference to the FIG. 1

In an embodiment of 211 and at 212, the SDTM identifies at least one extended SQL statement within the DDL statement. This can includes a variety of enhanced and extended SQL statement to accommodate the novel in-memory SDT.

For example, at 213, the SDTM identifies a first extended SQL statement as a size for housing the streaming data in the memory.

In an embodiment of 213 and at 214, the SDTM identifies a second extended SQL statement as a total number of processing units (such as Access Module Processors (AMPs)) in a parallel processing database environment for simultaneously accessing the instance and other instances of the SDT from memory. In other words, the SDT can be populated to multiple independent processing units and their memory for each such processing unit to process a unique portion of the SDT in a concurrent and parallel fashion to improve processing throughput.

In an embodiment of 214 and at 215, the SDTM identifies a third extended SQL statement as a total size for housing each of the original instance and other instances in the memory or other memory associated with each of the processing units.

In an embodiment, at 216, the SDTM defines the instance of the SDT based on a single source that supplies and streams the streaming data over one or more networks.

In an embodiment, at 217, the SDTM defines the instance of the SDT based on multiple sources that supply and stream the streaming data over one or more networks.

In an embodiment, a database administrator initially defines the instances of the SDT using extended DDL statements for the database interface of a database. The extended DDL statements embedded in an enhanced streaming data application, such as the streaming data application 131 of the FIG. 1.

At 220, the SDTM accesses a database interface of a database to create an instance of the SDT in wholly in memory.

At 230, the SDTM receives streaming data from at least one streaming data source over a network or a plurality of networks.

At 240, the SDTM populates the streaming data into the instance of the SDT through the database interface.

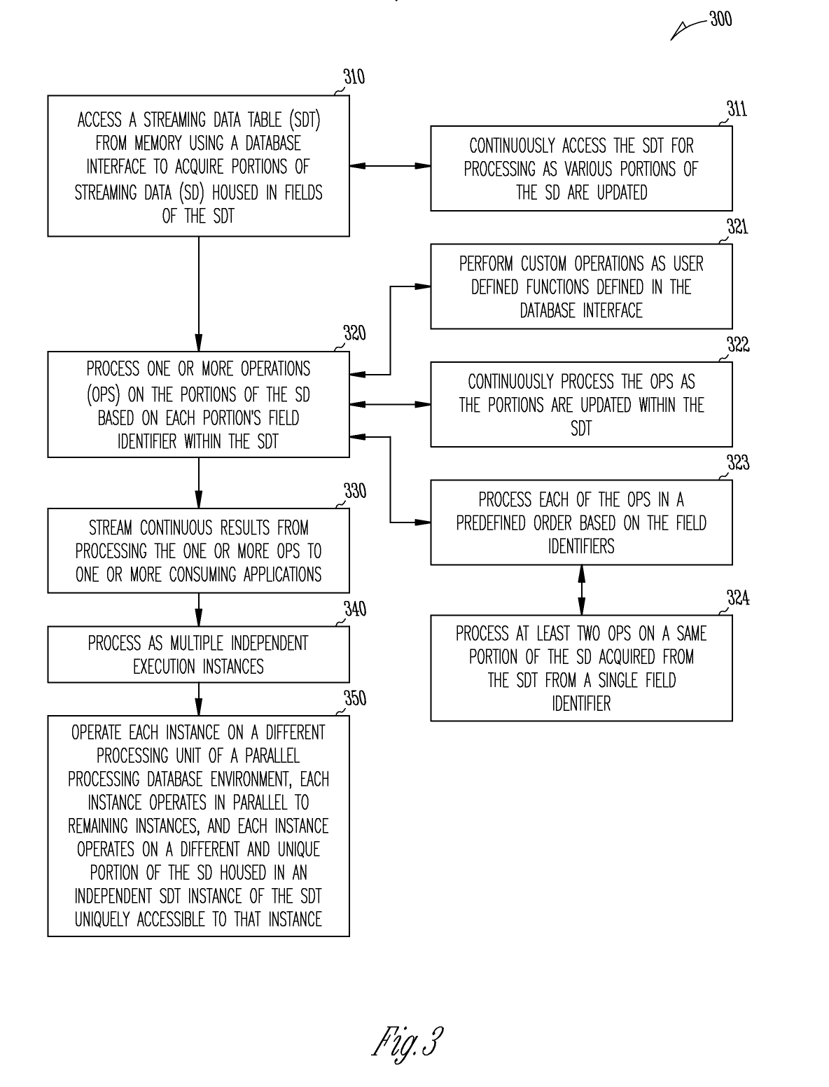

The SDTM continuously uses the database interface to update the SDT in memory as the streaming data is received from the streaming data source(s). The instance of the SDT in memory is then continuously available to a continuous query (CQ) or streaming engine, such as the CQ 133 discussed above with reference to the FIG. 1 or the streaming engine described below with reference to the FIG. 3.

FIG. 3 is a diagram of another method 300 for processing streaming data, according to an example embodiment. The method 300 (hereinafter “streaming engine”) is implemented as executable instructions as one or more software modules within memory and/or a non-transitory computer-readable storage medium that execute on one or more processors, the processors specifically configured to execute the streaming engine. Moreover, the streaming engine is programmed within memory and/or a non-transitory computer-readable storage medium. The streaming engine has access to one or more network, which can be wired, wireless, or a combination of wired and wireless.

The streaming engine represents processing that continuously processes streaming data using the in-memory SDT 132 produced by the SDTM of the FIG. 2 or the streaming data application 131 of the FIG. 1 for purposes of generating and streaming results 135 that are streamed to consuming application 136.

In an embodiment, the streaming engine is the CQ 133 of the FIG. 1.

At 310, the streaming engine accesses a SDT from memory using a database interface to acquire portions of the SD housed in fields of the SDT.

In an embodiment, the SDT is the SDT 132 of the FIG. 1.

In an embodiment, the SDT is the instance of the SDT created and populated by the SDTM of the FIG. 2.

In an embodiment, at 311, the streaming engine continuously accesses the SDT for processing as various portions of the SD are updated within the SDT and received from streaming sources.

At 320, the streaming engine processes one or more operations on the portions of the streaming data based on each portion's field identifier within the SDT. Essentially what was conventionally unstructured or structured with tagging and objects is now structured within the SDT for processing.

According to an embodiment, at 321, the streaming engine performs custom operations as user-defined functions defined in the database interface.

In an embodiment, at 322, the streaming engine continuously processes the operations as the portions are updated within the SDT. So, as streaming data is updated it is processed in real time.

In an embodiment, at 323, the streaming engine processes each of the operations in a predefined order based on the field identifiers of the SDT. This provides the conventional feature of an interconnected graph driven conventionally by objects and tagging and driven herein by structure of the SDT.

In an embodiment of 323 and at 324, the streaming engine processes at least two operations on a same portion of the streaming data acquired from the SDT from a single field identifier. So, the streaming data can initiate a series of operations.

At 330, the streaming engine streams continuous results from processing the one or more operations to one or more consuming applications for viewing and/or further processing.

According to an embodiment, at 340, the streaming engine can process as multiple independent execution instances in a parallel fashion.

In an embodiment of 340 and at 350, each instance of the streaming engine can operate on a different processing unit (such as an AMP) of a parallel processing database environment. Each instance of the streaming engine operates in parallel to the remaining instances of the streaming engine. Moreover, each instance of the streaming engine operates on a different and unique portion of the streaming data housed in an independent SDT instance of the SDT, which is uniquely accessible to that instance of the streaming engine.

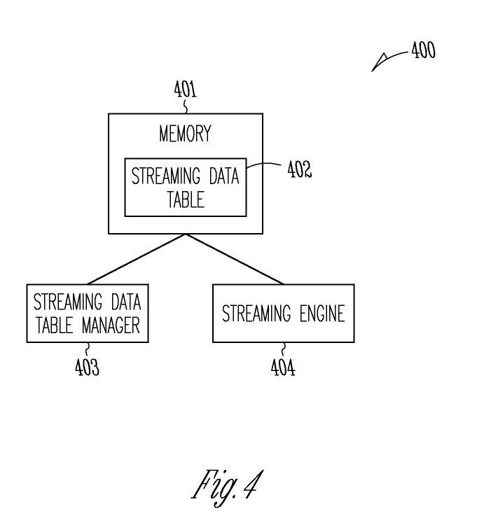

FIG. 4 is a diagram of a streaming processing system 400, according to an example embodiment, according to an example embodiment. The streaming processing system 400 includes hardware components, such as memory and one or more processors. Moreover, the streaming processing system 400 includes software resources, which are implemented, reside, and are programmed within memory and/or a non-transitory computer-readable storage medium and execute on the one or more processors, specifically configured to execute the software resources. Moreover, the streaming processing system 400 has access to one or more networks, which are wired, wireless, or a combination of wired and wireless.

In an embodiment, the streaming processing system 400 includes one or more of the components of the data consuming environment of the FIG. 1.

In an embodiment, the streaming processing system 400 includes, inter alia, the SDTM of the FIG. 2.

In an embodiment, the streaming processing system 400 includes, inter alia, the streaming engine of the FIG. 3.

In an embodiment, the streaming processing system 400 includes, inter alia, the SDT 132 of the FIG. 1.

In an embodiment, the streaming processing system 400 includes, inter alia, the streaming data application 131 of the FIG. 1.

In an embodiment, the streaming processing system 400 includes, inter alia, the CQ 133 of the FIG. 1.

In an embodiment, the streaming processing system 400 includes, inter alia, the database 134 of the FIG. 1.

The streaming processing system 400 includes a memory 401, a SDT 402, a SDTM 403, and a streaming engine 404.

The memory 401 includes at least one instance of the SDT 402 with fields of the SDT 402 having a unique portion of streaming data.

The SDTM 403 is adapted and configured to: execute on at least one processor, define and create the at least one instance of the SDT 402, and populate each unique portion of the streaming data to that portion's designated field.

According to an embodiment the SDTM 403 is further adapted and configured to use one or more extended DDL statements to define the SDT 402.

The streaming engine 404 is adapted and configured to: execute as multiple independent instances on multiple processing units of a parallel processing database environment, continuously access the fields of the SDT 402 as each field is updated with the streaming data, continuously process operations on each portion of the streaming data with each update to produce results, and stream the results as produced to consuming applications.

According to an embodiment, the streaming engine 404 is further adapted and configured to ensure each independent instance accesses and processes different portions of the streaming data housed in the fields of the SDT 402 from remaining independent instances.

One now appreciates how streaming data can be processed in a structured relational database manner utilizing an enhanced database interface and through a continuously updated in-memory table to process and produce results in real time.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
defining a Streaming Data Table (SDT);
accessing a database interface to create an instance of the SDT in memory;
receiving streaming data from at least one streaming source over a network; and
populating the streaming data into the instance of the SDT through the database interface.

2. The method of claim 1, wherein defining further includes receiving a Data Definition Language (DDL) statement for defining the instance of the SDT.

3. The method of claim 2, wherein receiving further includes identifying at least one extended Structure Query Language (SQL) statements within the DDL statement.

4. The method of claim 3, wherein identifying further includes identifying a first extended SQL statement as a size for housing the streaming data in the memory.

5. The method of claim 4, wherein identifying further includes identifying a second extended SQL statement as a total number of processing units in a parallel processing database environment for simultaneously accessing the instance and other instances of the SDT.

6. The method of claim 5, wherein identifying further includes identifying a third extended SQL statement as a total size for each of the instance and other instances in the memory.

7. The method of claim 1, wherein defining further includes defining the instance of the SDT based on a single source for the streaming data.

8. The method of claim 1, wherein defining further includes defining the instance of the SDT based on multiple sources for the streaming data.

9. The method of claim 1, wherein defining further includes defining access control and security on the instance of the SDT through the database interface.

10. A method, comprising:
accessing a Streaming Data Table (SDT) from memory using a database interface to acquire portions of streaming data housed in fields of the SDT;
processing one or more operations on the portions of the streaming data based on each portion's field identifier within the SDT; and
streaming continuous results from processing the one or more operations to one or more consuming applications.

11. The method of claim 10 further comprising, processing the method as multiple independent execution instances.

12. The method of claim 11, wherein processing further includes operating each instance on a different processing unit of a parallel processing database environment, wherein each instance operates in parallel to remaining instances, and wherein each instance operates on a different and unique portion of the streaming data housed in an independent SDT instance of the SDT uniquely accessible to that instance.

13. The method of claim 10, wherein accessing further includes continuously accessing the SDT for processing as various portions of the streaming data are updated.

14. The method of claim 10, wherein processing further includes performing custom operations as user defined functions defined in the database interface.

15. The method of claim 10, wherein processing further includes continuously processing the operations as the portions are updated within the SDT.

16. The method of claim 10, wherein processing further includes processing each of the operations in a predefined order based on the field identifiers.

17. The method of claim 16, wherein processing further includes processing at least two operations on a same portion of the streaming data acquired from the SDT from a single field identifier.

18. A processor-implemented system, comprising:
a memory having at least one instance of a Streaming Data Table (SDT) with fields of the SDT having a unique portion of streaming data; and
a SDT manager adapted and configured to: i) execute on at least one processor, ii) define and create the at least one instance of the SDT, and iii) populate each unique portion of the streaming data to that portion's designated field; and
a streaming engine adapted and configured to: i) execute as multiple independent instances on multiple processing units of a parallel processing database environment, ii) continuously access the fields of the SDT as each field is updated with the streaming data, iii) continuously process operations on each portion of the streaming data with each update to produce results, and iv) stream the results as produced to consuming applications.

19. The system of claim 18, wherein the SDT manager is further adapted and configured, in ii), to use one or more extended Data Definition Language (DDL) statements to define the SDT.

20. The system of claim 18, wherein the streaming engine is further adapted and configured, in ii), to ensure each independent instance accesses and processes different portions of the streaming data housed in the fields of the SDT from remaining independent instances.
